(19) United States
(12) Patent Application Publication
(10) Pub. No.: US 2015/0122008 A1
(43) Pub. Date: May 7, 2015

(54) RADIOSONDE POWER SOURCE DEVICE AND RADIOSONDE

(71) Applicant: MEISEI ELECTRIC CO., LTD., Gunma (JP)

(72) Inventor: Kensaku Shimizu, Gunma (JP)

(21) Appl. No.: 14/400,124

(22) PCT Filed: Sep. 18, 2012
(86) PCT No.: PCT/JP2012/005941

§ 371 Date: Nov. 10, 2014

(51) Int. Cl. H02J 7/00; G01W 1/08

(52) U.S. Cl. CPC H02J 7/007; G01W 1/08
USPC 73/170.28; 307/154

(57) ABSTRACT

The present invention can be made more lightweight even if a dry cell is used as a power source battery, can supply a necessary voltage at a battery capacity corresponding to an observation time, and can generate a predetermined electromotive force even in extremely low-temperature environments, This radiosonde power source device supplies driving electrical power to an apparatus tor processing and transmitting observation information resulting from, observing meteorological phenomena of the upper atmosphere, and has; a dry cell such as a lithium battery having a rated voltage lower than the driving voltage of the apparatus; and one or more step-up power source circuits that step-up the voltage of the dry cell to a predetermined voltage.

### TECHNICAL FIELD

The present invention relates to a power source device mounted on a radiosonde which is flown on a balloon to make meteorological observations in the upper air.

### BACKGROUND ART

A radiosonde for observing the upper atmosphere measures a wind direction, wind speed, atmospheric pressure, temperature, and humidity in the upper atmosphere, and transmits measurement information to the ground by using a transmitter. A water-activated battery has conventionally been used as a main power source of a power source device for driving the equipment of the radiosonde. The reason is that the water-activated battery suitably satisfies requirements such as having a sufficient voltage (approximately 5 V to 1.2 V) to operate the transmitter of the radiosonde, being operable at surface temperatures and in extremely low temperature environments of near −90° C. up in the air, and having a weight light enough to be flown on a rubber balloon.

By the way, the water-activated battery with high self-heating was less likely to cause a voltage drop and could supply sufficient voltage even in extremely low temperature environments. However, the water-activated battery has sometimes caused operational inconvenience because its operation cannot be stopped once water is injected.

For such a reason, the use of dry cells has been becoming mainstream in recent years as a power source battery of the radiosonde power source device (Patent Literature 1).

Dry cells typically have a rated voltage of 1.5 V or 3.0 V per cell. For use with a radiosonde, a plurality of dry cells are connected in series to obtain a predetermined voltage.

However, if a plurality of dry cells are used in the power source unit of the radiosonde, the power source device increases in weight. The balloon also becomes larger in volume, and the gas volume of hydrogen gas or the like filled into the balloon increases to increase the cost needed for a release.

If manganese or alkali dry cells are used, the aqueous electrolyte solution inside can freeze and cause a voltage drop in low temperature environments. The dry cells have thus been covered with heat insulators for antifreeze measures.

Dry cells containing a nonaqueous electrolyte solution, such as a lithium battery, are operable at relatively low temperatures and thus do not need heat insulators as antifreeze measures. To obtain a high voltage, a plurality of such dry cells nevertheless need to be connected in series like alkali dry cells.

Each lithium cell has an electric capacity too large to consume within the observation time of a radiosonde, which is approximately two to three hours. The use of a plurality of lithium batteries connected in series translates into mounting an electric capacity more than necessary, resulting in wasted cost.

### CITATION LIST

### Patent Literature

Patent Literature 1: Japanese Patent Application Laid-Open No. Hei. 8-307150

### SUMMARY OF INVENTION

### Technical Problem

An object of the present invention is to provide a radiosonde power source device of which weight can foe reduced even if a dry cell is used as a power source battery, which can supply a necessary voltage with a battery capacity corresponding to an observation time, and which can generate a predetermined electromotive force in extremely low temperature environments, and a radiosonde.

### Solution to Problem

A radiosonde power source device for solving the problem of the present invention is a radiosonde power source device for supplying driving power to an apparatus that processes and transmits observation information obtained by meteorological observations in the upper atmosphere, the radiosonde power source device including: a dry cell that has a rated voltage lower than driving voltage of the apparatus; and one or a plurality of step-up power source circuits that each step up the voltage of the dry cell to a predetermined voltage.

In the foregoing configuration, the dry cell is a lithium battery or an assembled battery of lithium batteries.

In the foregoing configuration, the step-up power source circuit is a DC-DC Converter.

in the foregoing configuration, the radiosonde power source device includes a regulator that steps down a step-up voltage of the step-up power source circuit to a voltage higher than the voltage of the dry cell; the apparatus includes an internal circuit unit that processes observation information from a sensor unit for making meteorological observations in the upper atmosphere and a transmission unit that transmits information processed by the internal circuit unit; and the radiosonde power supply device supplies the step-up voltage of the step-up power source circuit to the transmission unit and a step-down voltage of the regulator to the internal circuit unit.

A configuration of a radiosonde for solving the problem of the present invention includes: the radiosonde power source device having the foregoing configuration; a sensor unit to which the power source device supplies power and that makes meteorological observations in the upper atmosphere; an apparatus that processes and transmits observation information observed by the sensor unit; and a container that accommodates the power source device and the apparatus.

### Advantageous Effects of Invention

According to the radiosonde power source apparatus of the present invention, the step-up power source circuit such as a step-up DC-DC converter steps up the voltage of the dry cell to a predetermined voltage. The radiosonde can thus perform observations, for example, with the electric capacity of one dry cell. The number of dry cells can be significantly reduced to allow a significant reduction in the weight of the radiosonde.

Consequently, the balloon can be made smaller in size and the volume of the hydrogen gas to be filled into the balloon can be significantly reduced. This can significantly reduce the cost needed for a release.

Moreover, even if the radiosonde falls on the ground after the end of the observations, the lighter weight of the radiosonde significantly reduces risks when falling on the ground.

Since the dry cell is connected to the step-up power source circuit such as a step-up DC-DC coverer, the dry cell causes self-heating. As the ambient temperature decreases, the current of the dry cell increases to increase the self-heating temperature. Consequently, as the altitude increases, the ambient temperature decreases and the voltage of the dry cell drops temporarily, but the increase of the self-heating temperature alleviates the voltage drop to maintain a generally constant voltage. A stable voltage can thus be supplied.

### BRIEF DESCRIPTION OF DRAWINGS

FIG. 1 is a block diagram of electric circuit, showing an embodiment of a radiosonde according to the present invention.

FIG. 2 is a block diagram showing a first embodiment of a power source device of the radiosonde shown in FIG. 1.

FIG. 3 is a block diagram showing a second embodiment of the power source device of the radiosonde shown in FIG. 1.

FIG. 4 is a circuit diagram of a step-up power source circuit shown in FIGS. 2 and 3.

FIG. 5 is a diagram showing a relationship between a voltage of the dry cell shown in FIG. 4 and a change in ambient temperature, in relation to self-heating temperature.

### DESCRIPTION OF EMBODIMENTS

Hereinafter, the present invention will be described in detail on the basis of embodiments shown in the drawings.

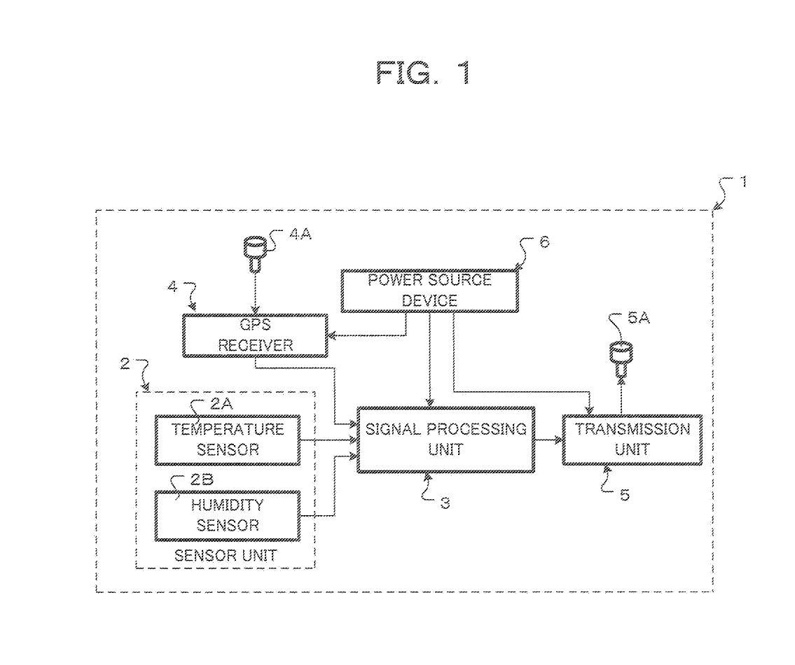

FIG. 1 is a block diagram of an electric circuit, showing an embodiment of a radiosonde according to the present invention.

In FIG. 1, a radiosonde 1 to be flown on a balloon outputs detection information detected by a temperature sensor 2A and a humidity sensor 2B of a sensor unit 2 to a signal processing unit 3. A GPS (Global Positioning System) receiver 4 outputs position information obtained from a GPS antenna 4A to the signal processing unit 3. The signal processing unit 3 outputs the received various types of observation information to a transmission unit 5, and transmits the observation information from a transmission antenna 5A to a reception facility on the ground.

In the present embodiment, a wind direction, wind speed, and atmospheric pressure are measured on the basis of a moving speed and an altitude obtained by the GPS. The radiosonde according to the present invention is not limited to such a configuration.

A power source device 6 supplies the signal processing unit 3, the GPS receiver 4, and the transmission unit 5 with power at predetermined voltages.

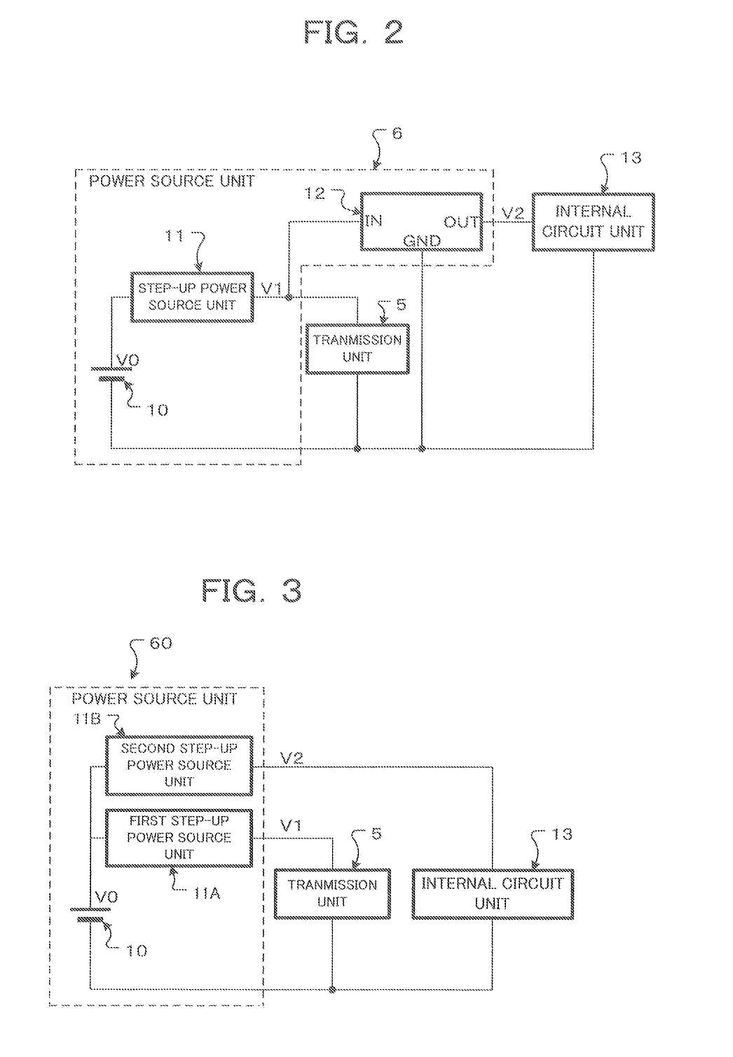

As shown in FIG. 2, the power source device 6 uses a dry cell 10 having a voltage V0 as a power source. A step-up power source circuit 11 such as a DC-DC converter steps up the voltage V0 of the dry cell 10 to obtain a voltage V1 higher than the voltage V0 (V0<V1). The transmission unit 5 is driven by the voltage V1 stepped up by the step-up power source circuit 11. An internal circuit unit 13 (the signal processing unit 3 and the GPS receiver 4) has a driving voltage lower than the driving voltage V1 of the transmission unit 5 (V2<V1). The voltage V1 stepped up by the step-up power source circuit 11 is then stepped down to the voltage V2 by a three-terminal regulator 12, and the voltage V2 is supplied to the internal circuit unit 13.

A lithium battery having a nominal rating of 1.5 V or 3.0 V or an assembled battery of lithium batteries is used as the dry cell 10 of the power source device 6. The step-up power source circuit 11 steps up the voltage V0 of the dry cell 10 to a primary voltage V1 of approximately 5 V to 12 V.

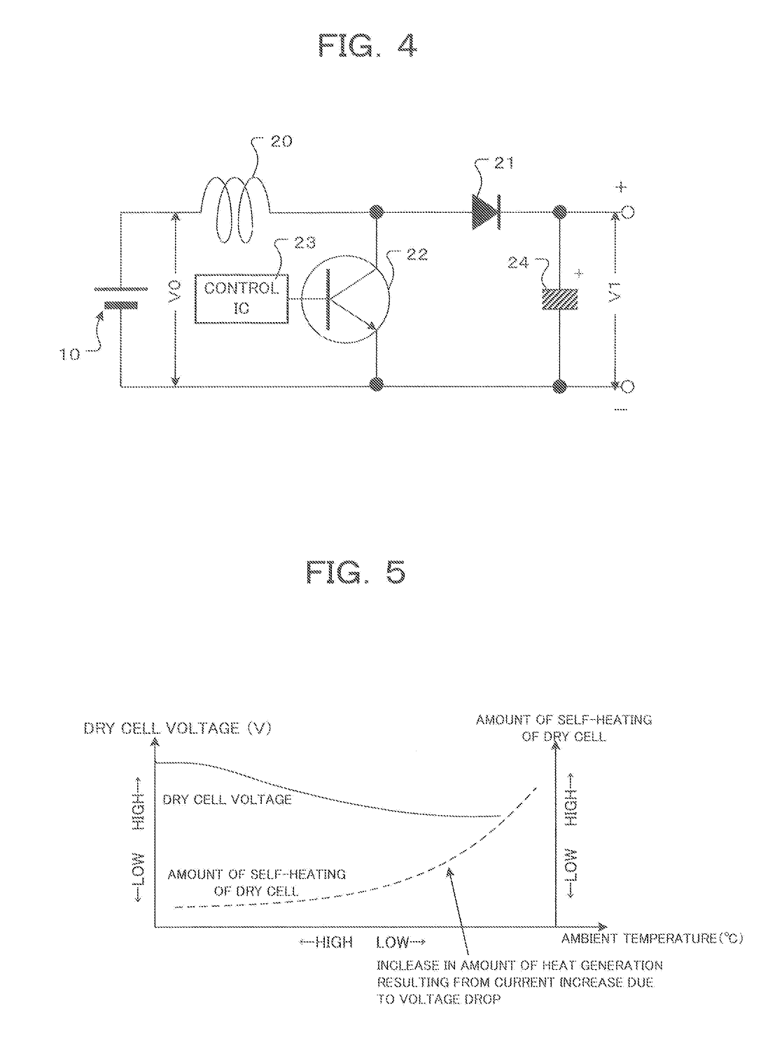

Examples of the step-up power source circuit 11 may include a non-insulated DC-DC converter shown in FIG. 4. In the DC-DC converter, when a switching transistor 22 which is ON-OFF controlled by a control IC is turned ON, all the current from the dry cell 10 flows through a choke coil 20. The choke coil 20 produces an electromotive force in the direction of blocking the current flowing in, and thereby accumulates energy. Next, when the switching transistor 22 is turned OFF, the choke coil 20 produces an electromotive force in the direction of sustaining the current, and thereby releases the accumulated energy. This generates a high induction voltage across the choke coil 20. A capacitor 24 is charged with a voltage obtained by adding the voltage of the dry cell 10 to the induction voltage. Here, a diode 21 prevents the voltage with which the capacitor 24 is charged from flowing backward to the dry cell 10.

The DC-DC converter is configured such that the choke coil 20, the diode 21, the switching transistor 22, the control IC 23, and the capacitor 24 are mounted on a printed-circuit board. The DC-DC converter according to the present embodiment has a weight of approximately 5 g to 10 g. The dry cell 10 has a weight of approximately 15 g to 30 g.

Here, without using the DC-DC converter, in order to obtain a primary voltage V1, it must be connected to a series of three dry cells 10. Further, in order to drive the internal circuit 13, a structure that uses a 3-terminal regulator 12. As compared to such a conventional configuration, the configuration of the first embodiment differs in that the number of dry cells 10 is two fewer and the DC-DC converter is added. The dry cell 10 have a weight of approximately 15 g per cell. The DC-DC converter has a weight of approximately 5 g.

Consequently, the power source device 6 according to the present embodiment can employ the DC-DC converter to reduce weight by approximately 30 g as compared to the conventional configuration.

The radiosonde 1 according to the present embodiment has a total weight of approximately 110 g. The weight reduction of approximately 30 g therefore allows a significant reduction in the weight of the radiosonde 1.

The lithium battery used as the dry ceil 10 has an electric capacity of approximately three hours per cell. The series connection of three cells increases the electric capacity three times. However, since the observation time of the radiosonde 1 is approximately two to three hours, a single lithium battery will suffice in terms of the electric capacity.

According to the present embodiment, the voltage obtained by connecting a plurality of dry cells in series can be obtained by using one dry cell 10 and the step-up power source circuit 11 being the DC-DC converter. Consequently, the power source batteries which have accounted for a large proportion of the total weight of the radiosonde can be reduced. The newly-added step-up power source circuit causes only a slight increase in weight. The radiosonde can perform observations by using the one dry cell 10, and can be significantly reduced in weight.

The weight reduction of the radiosonde can make the balloon smaller in volume, and allows a significant reduction in the amount of hydrogen gas or the like to be filled into the balloon. This can significantly reduce the cost needed for a release.

In the step-up DC-DC converter, as shown in FIG. 4, when the switching transistor 22 is ON, both ends of the choke coil 20 are connected to both ends of the dry cell 10 and the current flows through the choke coil 20. The dry cell 10 thereby causes self-heating due to the internal resistance of the dry cell 10.

As the released radiosonde 1 rises and increases in altitude, the ambient temperature starts to decrease. FIG. 5 is a diagram showing a relationship between the voltage of the dry cell and a change in the ambient temperature, in relation to the amount of self-heating (increase in the amount of heat generation resulting from a current increase due to a drop in voltage) of the dry cell. The voltage of the dry cell starts to drop as the the ambient temperature decreases. The voltage drop of the dry cell 10, however, increases the current to flow through the choke coil 20. The amount of heat generation of the dry cell 10 resulting from the current increase due to the voltage drop increases, and the heating temperature of the dry cell 10 becomes higher. The higher heating temperature of the dry cell 10 suppresses the tendency for the electromotive force to decrease. A generally constant voltage is thus maintained even if the radiosonde 1 increases in altitude and the ambient temperature falls.

According to the present embodiment, the step-up DC-DC converter can be used to make the dry cell 10 cause self-heating because of a current increase due to a voltage drop by consumption. A decrease of the electromotive force in extremely low temperature environments can thus be suppressed without using a heat insulating member. Since no heat insulating member is needed, the radiosonde can be reduced in weight.

The radiosonde of lighter weight can significantly reduce risks when falling on the ground.

The circuit board and the battery of the radiosonde 1 are accommodated in a not-shown container. Various antennas are supported and extended outward from the container. The container is connected to, for example, a hydrogen gas-filled balloon via a string and released.

### Second Embodiment

FIG. 3 is a block diagram showing a second embodiment of the power source device of the radiosonde shown in FIG. 1.

In the first embodiment shown in FIG. 2, the regulator 12 is used to drive the internal circuit unit 13. In the present embodiment, a voltage V2 stepped up by a second step-up power source circuit 11B having the same configuration as that of the step-up power source circuit 11 is supplied to the internal circuit 13. A voltage V1 stepped up by a first step-up power source circuit 11A having the same configuration as that of the step-up power source circuit 11 is supplied to the transmission unit 5

In the present embodiment, the voltage V0 of one dry cell 10 is stepped up to the voltages V1 and V2 (V2<V1) by the first step-up power source circuit 11A and the second step-up power source circuit 11B, respectively. If there is provided a circuit unit to be driven by a voltage different from the voltages V1 and V2, a new step-up power source circuit may be added to supply a voltage V3. The number of step-up source circuits 11 is not limited to two.

### INDUSTRIAL APPLICABILITY

The radiosonde power source device according to the present invention can be configured by mounting an IC and a choke coil on a printed-circuit board. The radiosonde power source device can be integrally assembled with the printed-circuit board of the transmission unit and the internal circuit of the radiosonde. The radiosonde is hung on a balloon filled with hydrogen gas, and released to make meteorological observations in the upper atmosphere.

### REFERENCE SIGNS LIST

1 radiosonde

2 sensor unit

3 signal processing unit

4 GPS receiver

5 transmission unit

6, 60 power source device

10 dray cell

11 step-up power source circuit
11A first step-up power source circuit, 11B second step-up power source circuit

12 regulator

13 internal circuit unit

20 choke coil

21 diode

22 switching transistor

23 control IC

24 capacitor

1. A radiosonde power source device for supplying driving power to an apparatus that processes and transmits observation information obtained by meteorological observations in the upper atmosphere, the radiosonde power source device comprising:
a dry cell that has a rated voltage lower than driving voltage of the apparatus; and
one or a plurality of step-up power source circuits that each step up the voltage of the dry cell to a predetermined voltage.

2. The radiosonde power source device according to claim 1, wherein the dry cell is a lithium battery or an assembled battery of lithium batteries.

3. The radiosonde power source device according to claim 1, wherein the step-up power source circuit is a DC-DC converter.

4. The radiosonde power source device according to claim 1, comprising a regulator that steps down a step-up voltage of the step-up power source circuit to a voltage higher than the voltage of the dry cell, and wherein the apparatus includes an internal circuit unit that processes observation information from a sensor unit for making meteorological observations in the upper atmosphere and a transmission unit that transmits information processed by the internal circuit unit, and the radiosonde power supply device supplies the step-up voltage of the step-up power source circuit to the transmission unit and a step-down voltage of the regulator to the internal circuit unit.

5. A radiosonde comprising: the radiosonde power source device as set forth in claim 1; a sensor unit to which the power source device supplies power and that makes meteorological observations in the upper atmosphere; an apparatus that processes and transmits observation information observed by the sensor unit; and a container that accommodates the power source device and the apparatus.
